(19) United States
(12) Patent Application Publication
(10) Pub. No.: US 2007/0234277 A1
(43) Pub. Date: Oct. 4, 2007

(54) Method and apparatus for model-driven business performance management

(76) Inventors: Hui Lei, Scarsdale, NY (US); Liangzhao Zeng, Ossining, NY (US)

Correspondence Address: Whitham, Curtis, & Christofferson, P.C., Suite 340, 11491 Sunset Hills Road, Reston, VA, 20190, US

(21) Appl. No.: 11/337,658

(22) Filed: Jan. 24, 2006

(51) Int. Cl. G06F 9/44

(52) U.S. Cl. 717/104

(57) ABSTRACT

A model-driven approach to business performance management (BPM) uses a hybrid compilation-interpretation approach to map an observation model to a runtime executable. The data aspect of the observation model is first extracted and refactored to facilitate runtime access. Next, the operational aspect of the model, such as logic for metric computation and situation detection, is compiled into code. Finally, a runtime engine interprets the refactored model and dynamically loads the generated code, according to the meta-model.

### BACKGROUND OF THE INVENTION

1. Field of the Invention

The present application generally relates to Business Performance Management (BPM) systems and, more particularly, to a hybrid approach (compile-interpret) to implement a model-driven BPM system.

2. Background Description

In order to function effectively in today's business environment, organizations must have visibility of their business activities and operation performance at all times. This allows them to stay competitive and profitable. BPM is a new generation enterprise data management system that focuses on monitoring business operations. It provides a comprehensive view of business operation in the organization. The benefit of adopting BPM solution includes: (1) Increasing revenue by speeding response time, actions and regulatory changes; (2) Effectively managing risk by providing information in the right context to facilitate decision making; (3) Improving customer satisfaction by allowing continuous improvement of business processes.

### SUMMARY OF THE INVENTION

According to the present invention, there is provided a novel hybrid approach (compile-interpret) to implement a model-driven BPM. First, based on observation meta-model, a model transformer refactors user defined observation models and facilitates the efficient execution of observation model. A compiler generates libraries for event processing, metric computation and situation detection. A runtime engine (interpreter) dynamically loads the libraries to realize operation of observation models. This hybrid approach is the key enabling technique for efficient and dynamic BPM.

In general, models provide abstractions of a system that allow users to reason about that system by ignoring extraneous details. In particular, observation models are used to describe BPM solutions. Observation models are declaratively defined by business analysts. The models define metrics that are used to measure the performance of business operations. After the observation model is deployed, the runtime engine computes metric values in real time by processing data in both live events and persistence data store, and generates alerts once the situations occur.

When adopting a model-driven approach, building a BPM solution is central around observations models. After the models have been created, a series of transformations are run on them. The transformations generate the executable code that is deployed into the runtime platform. This approach differs from existing BPM solutions. In existing approaches, developers focus on time-consuming platform dependent implementations. In the Model-Driven approach according to the present invention, solution providers can concentrate on business processes and observation models, without worrying about platform specific implementation details. Further, the models can be continuously improved as the transformation and deployment are performed systematically by the model-driven architecture.

Among the major challenges of implementing model-driven BPM is that there are large numbers of the business entities that need to be monitored, and these business entities may be associated with a large number of metrics. Further, the data structure of the metric may be complex. The challenge is to design a BPM runtime engine that is able to compute and maintain the large amount of metric data in a timely manner. The data source that is processed by the runtime engine can come from live events and also persistent datastores. The runtime engine is also required to efficiently track the state of context instances, and metrics, in order to detect business situations.

The present invention is a novel hybrid compile-interpret to implement the model-driven architecture and aims for efficient and timely management for business performance and situation detection. Further, the invention provides a mechanism for managing dynamic evolution of observation models. The major contributions of this solution are:
Model Transformation. The model transformation technique implemented by the invention decomposes observation models into information logic and model specific logic. In order to facilitate efficient runtime execution, the technique not only re-organizes the model information to facilitate efficient runtime access, but also pre-processes the model specific logic to facilitate code generation.
Unified and Efficient Runtime Store. The runtime data-store implemented by the invention provides efficient management of runtime objects. The observation meta-model uses an object-based data model. One approach is to use an object based store; however, there are performance issues in the currently available object-based datastores. Therefore, a relational datastore is desired to provide persistent support for the runtime objects. A unified data schema is designed that can be used by any observation models. To improve performance, the data schema stores the runtime objects vertically.
Customized Code Generation. The invention implements a model compiler that generates Java libraries for model specific logic (i.e., expression) in an observation model. A Java virtual machine is adopted as the execution platform in the preferred embodiment of the invention. This side-steps the need to develop a home-grow evaluation engine. There are many forms of expressions in an observation model. A Java class is generated for each expression, whereby customization can be performed based on the type of expression for gaining optimal computation performance. Additionally, pre-compiled Java code contributes to better evaluation performance.

The present invention is a new direction in area of enterprise data management applications. Traditional business intelligence (see, for example, Surajit Chaudhuri and Umeshwar Dayal, “An overview of data warehousing and olap technology”, SIGMOD Record, 26(1):65-74, 1997) or data warehouse solutions focus on generating reports that summarize the business performance. However, they only provide services that have pull-based information delivery capability. Further, such services can only be invoked periodically, which cannot satisfy the real-time requirement when evaluating business performance. Continual query (as described, for example, by Ling Lui, Calton Pu, and Wei Tang in “Continual queries for internet scale event-driven information delivery”, IEEE Knowledge and Data Engineering, 11(4):610-628, 1999) system is able to monitor updates to areas of interest and return results whenever the updates reach specified thresholds. It provides push-enabled, event-driven, content-sensitive information delivery capabilities, which can be considered as the enabling technology for implementing situation detection. However, in the continual query system, users need to manage the data schemas and query language provided by the continual query system is similar to SQL (Structured Query Language), which is not suitable for business analysts.

There is new emerging solution is called “sensomet” (see, J. Hellerstein, W. Hong, S. Madden, and K. Stanek, “Beyond average: Towards sophisticatd sensing with queries”, In Workshop on Information Processing In Sensor Networks (IPSN), 2003). It processes live event data in real time fashion, however, this technique is not suitable for realizing BPM. First, sensomet processes live event data only, while BPM processes data in both live events and persistence data stores. Second, sensomet focuses on approximate query because of the constraint of read and read only once. When monitoring business operation, such constraint is unnecessary. Precisely processing the data and computing exact metric values is critical for business operation monitoring and is not supported by sensomet. BPM solves these problems and offers a more complete and efficient solution.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram illustrating an example of an observation model;

FIG. 2 is a block diagram illustrating information organization in the observation model;

FIG. 3 is a block diagram illustrating the operation of the observation mode;

FIG. 4 is a block diagram illustrating the hybrid approach for the observation model execution according to the present invention;

FIG. 5 is a block diagram of a simplified refactored observation model data schema;

FIG. 6 is a block diagram illustrating a context instance tree;

FIG. 7 is a block diagram of the datastore data schema;

FIG. 8 is a table illustrating a snapshot of the runtime store; and

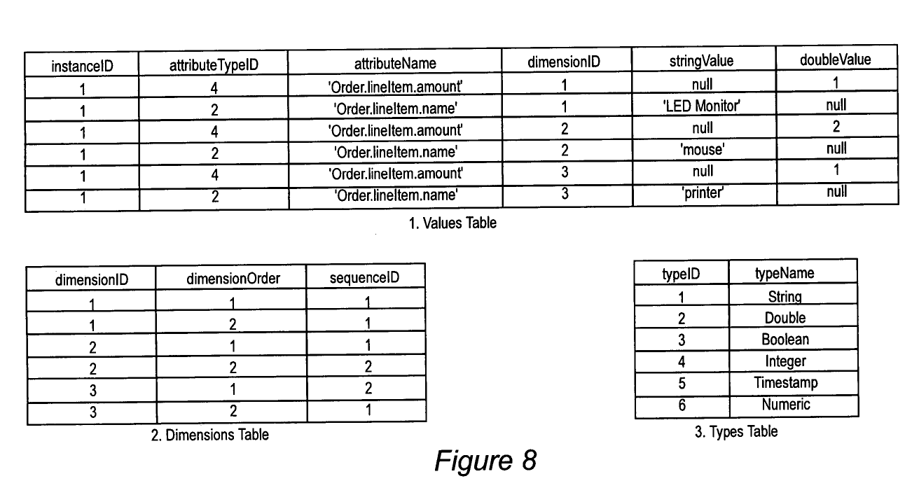

FIG. 9 is a flow diagram showing the main route of the runtime engine.

### DETAILED DESCRIPTION OF A PREFERRED EMBODIMENT OF THE INVENTION

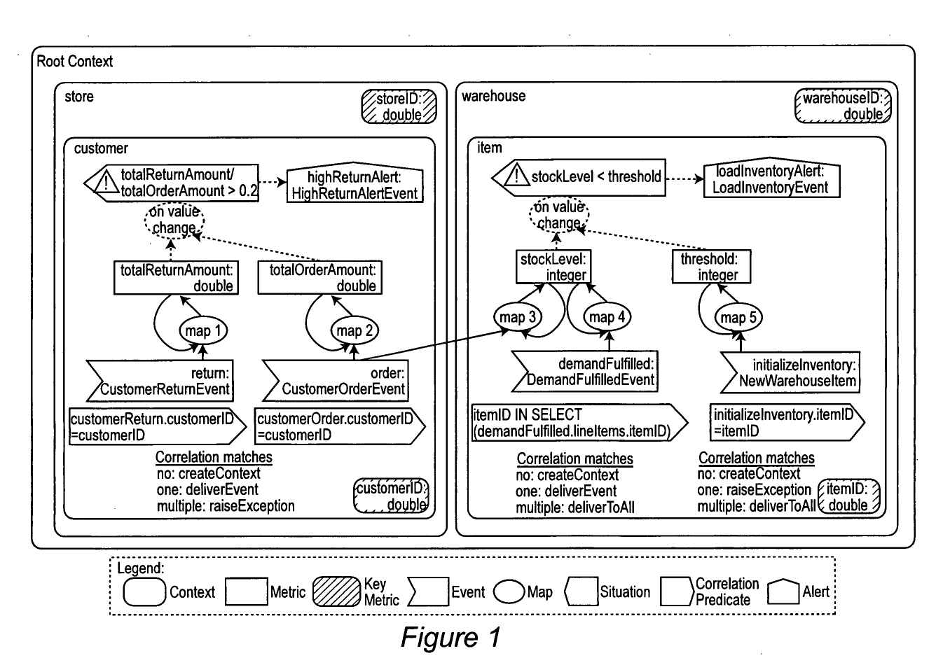

Referring now to the drawings, and more particularly to FIG. 1, there is shown an example of observation model to illustrate the design of observation meta-model. The requirements of an BPM solution are captured by an observation model. The specification of observation models is given by the observation meta-model. The meta-model is a simplified version of that which is described by Joachim H. Frank and Ghaly Gamil Stefanos in “Business Operations Metamodel”, Technical Report, International Business Machines Corp., January 2005. The meta-model describes two aspects of an observation model.

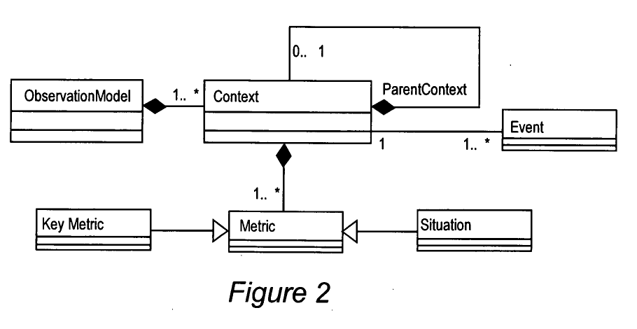

The information in an observation model is typically constructed top-down. Formally, an observation model (see Unified Modeling Language (UML) model in FIG. 2) contains a hierarchy of contexts. For example, in FIG. 1, the root context contains two contexts store and warehouse, and context store further contains context customer. A context corresponds to an entity to be monitored. There are two kinds of context: statically defined (for example, warehouse) or dynamically created (for example, items in a warehouse). From an information organization point of view, context can be considered as a container for metrics. Metrics are the knowledge about business operation performance of the entity being observed. As an example, a metric can be the stocklevel of a item in warehouse. More specifically, a key metric is used to identify a context instance. For example, storeID is the key metric that is used to identify context store. Situations are a Boolean type of metrics, and represent the gating conditions for generating alters. A context associates with a collection of events. Events report up-to-date status information about business operations, which are used to compute the value of metrics. It should be noted that the data structure for defining metrics and events can be primitive, structured, and single or multiple value type.

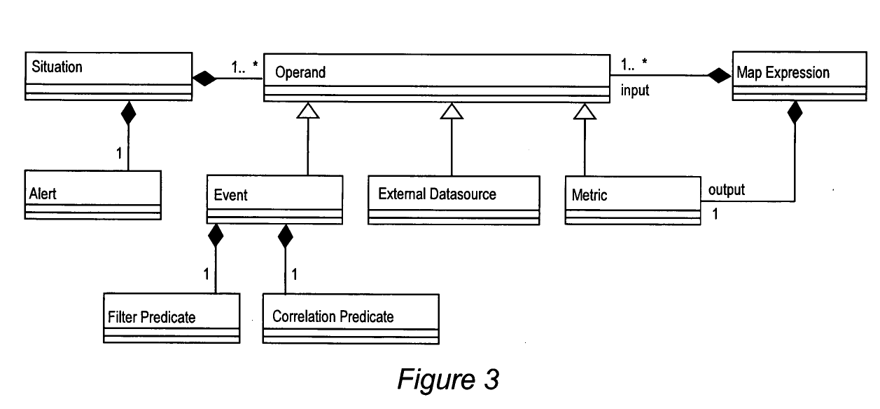

There are two aspects regarding the operation of an observation model (See UML model in FIG. 3): (1) The first aspect is how the events are being processed. An event is associated with a filter predicate and a correlation predicate. The filter predicates specify the types of events that need to be processed. Correlation predicates determine the associations between events and context instances. At runtime, an event is either correlated into existing context instances, or creates new context instance, or raise exception. It should be noted that a metric in the context is used to save the value of an event. (2) The second aspect is the metric network. A graphical model that captures the dependency relationships among metrics is adopted in the practice of this invention. The vertices represent either metrics or dependencies among metrics. The edges represent the relationship between a dependency and a metric: either inputslot or outputslot. Map expressions are used to denote the association between a dependency vertex and the input/output metrics. As an example, in FIG. 1, a map expression (map 3) is shown as:
item.stockLevel=minus(item.stockLevel,customer.order.lineItem.amount)

In this expression, minus is a dependency vertex, and item.stockLevel and customer.order.lineItem.amount are metric vertexes. The item.stockLevel and customer.order.lineItem.amount are inputslots and item.stockLevel is an outputslot of dependency minus. The metrics in a map expression may belong to different contexts. For example, in above expression, two metrics are from context item and customer respectively. The relationship supported by a metric network includes functional, probabilistic, system dynamics and extensible user-defined dependency. Currently, we focus on explicit functional dependency. It should be noted that the execution of an expression can be triggered by an incoming event, value changes of a metric, or occurrence of a situation.

If we consider the meta-model as a high level programming language, then an observation model can be considered a program. There are two approaches to executing a program, namely interpreting and compiling. An interpreter is a program that implements or simulates a virtual machine using the base set of instructions of a programming language as its machine language. The source code of a programming is directed executed on by the interpreter, without generating any extra code. A compiler is a program that translates the source code of a programming language into the object code. The object code can be executed directly on the machine where it was compiled.

Similarly, the two approaches to execute an observation model are either interpreting or compiling. It should be noted that the runtime platform can be also high level, such as J2EE. Java 2 Platform, Enterprise Edition (J2EE) defines the standard for developing component-based multitier enterprise applications. However, both approaches have drawbacks, given the stringent requirement of implementing BPM. We discuss adopting the interpreting approach first. The advantage of interpreting a model is that it is easy to realize the model evolution because the interpreter maintains all the model information. As described above, the information in the observation model is organized centrally around the contexts; however, the operation of the observation model is event-triggered. Therefore, certain information required by the runtime is scattered throughout the model. It is very costly for the interpreter to scan through the model at runtime. Also, developing an interpreter that can execute map expressions optimally becomes difficult, given that the operators in constructing map expressions can be relational, set, vector, scalar, etc. Further, the metric referenced in map expressions is not limited to the same context. To locate the associated instances of a metric, the interpreter needs to navigate through the hierarchy of contexts at runtime, which may also incur performance penalties.

While adopting a compiling approach can improve execution performance by generating customized code for individual models, the model information is embedded into generated code at compiling time. The compiling approach is therefore impractical to support model evolution and hot deployment. For example, in some cases, when a context instance is in its running state, the original model must still be used to compute the metric values. Such a context session based model evolution schema is very costly when implemented by a compiling approach because a scan through all the context instances is required to check the state, as this information is maintained by the generated code.

The present invention takes advantage of both approaches in the form of a hybrid approach. Three kinds of application logic are distinguished in a BPM solution: common logic, information logic and model specific logic. The common logic is defined in meta-model level, which is applied to any observation model. One example of common logic is the routine for processing events. The information logic includes information organization in the observation model. Model specific logic (e.g., map expression) is unique to each individual model.

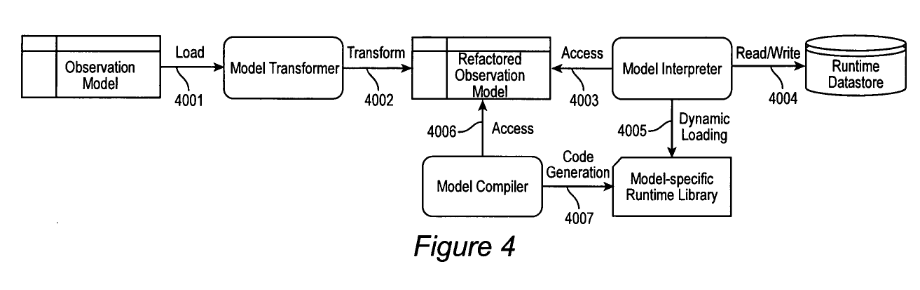

The hybrid approach of the invention consists of a model transformer, a model compiler, and a model interpreter, as shown in FIG. 4. At build time, the model transformer decomposes the observation model into information logic and model specific logic, in step 4001. Also, it transforms the context-oriented model into an event-oriented model, which allows a more efficient runtime access to the model information, in step 4002. The compiler accesses model information in Step 4006 and generates the object code for model specific logic in Step 4007. It should be noted that while J2EE is adopted as the runtime platform in the preferred embodiment of the invention, other platforms could be used. The object code of our model compiler is Java source code, which will be further compiled into a Java library for runtime execution. Finally, the interpreter implements the common logic and interprets the information logic. It accesses model information in Step 4003 and, in Step 4005, dynamically loads the model specific Java library to realize the operation of the observation model. It also accesses the runtime datastore to store persistent runtime data in Step 4004. In the following sections, we will present the design of these three components.

One of the key steps in the hybrid approach of this invention is to decompose observation models into information logic and model specific logic. Further, in order to facilitate interpretation and compilation, the model transformer possesses two main functionalities, namely (i) refactoring information logic; (ii) pre-processing model specific logic.

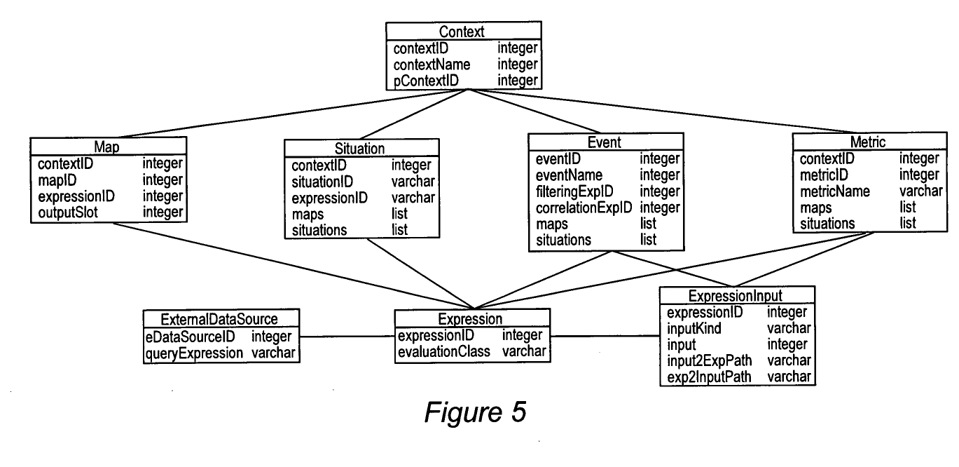

As discussed earlier, the design of the observation meta-model aims for facilitating the creation of the observation model. However, the organization of the data is not suitable for efficient runtime access. The model transformer reorganizes the model information (see data schema in FIG. 5). In the refactored model, a table is created for each type of elements in an observation model. Primary and foreign keys are used to represent the cross reference among the elements. For example, by foreign key contextID in table Metric, the metrics that are belonging to a context can be located.

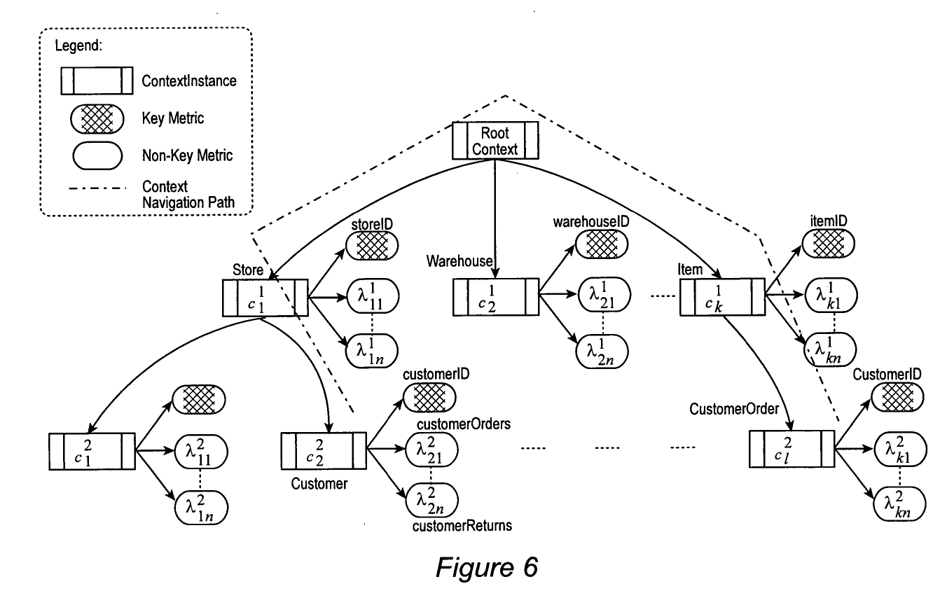

In the observation model, the model specific logic is presented in terms of expressions in metric network. Specifically, there are four kinds of expressions: event filter expression, event correlation expression, map expression and situation detection expression. Uniformly, these four types of expression can be denoted as:
f=x(c₁,λ₁,c₂,λ₂, . . . ,cₙ,λₙ,γ₁,γ₂, . . . ,γₘ,ε₁,ε₁,ε₂, . . . ,εₖ) (1)
where X is the operator and there are three kind of operands: metrics (λᵢ), events (γᵢ) and external data sources (εᵢ). In case of map expression, f represents c.λ, and λ is the metric being assigned the value and the c is the context that 1 belongs to. In order to facilitate the evaluation of expressions, two kinds of type-based pre-processing are performed by the model transformer at buildtime:
Determination of expressions that should be executed. In the operating an observation model, the execution of an expression can be triggered by an incoming event, value changes of a metric, or occurrence of a situation. However, for sake of model creation, information in an observation model is organized centra around contexts. Without reorganizing the information, full scanning on the observation model is required in order to determinate which expression should be execution whenever occurrence of event, value changes of a metric, or situation. Therefore, it is necessary to reorganize the information and index expressions based on their execution triggers. In our solution, the refactored model maintains tables for events, metrics and situations, where each entry of event, metric or situation indexes a collection of expressions that can be triggered by the entry. For example, if a metric is an operand of map m₁ and m₂, then the field of maps of the metric's entry of the table Metric is {m₁, m₂}. Such an index can be generated by analyzing the operands of the expressions. The computation results are saved in table Metric, Situation and Event (in the field maps and situations).
Determination of the navigation paths. At runtime, the generated context instances and associated metrics form a tree structure (See FIG. 6). The tree structure provides the parent-child relationship information (for example, context instance c₁¹ is the parent for context instance c₁²) as well as contained relationship among the context instance and metrics (for example, metric λ₁₁¹ belongs to context instance c₁¹). In an expression, the output and operands (i.e., metrics) may belong to different contexts, wherein a path exists between the output and each operand. Based on the original context instance c that the output belongs and destination context instance cᵢ that the operand metric belongs to, the navigation path can be computed as </μ₁/μ₂/ . . . /μₖ>. μᵢ in the path represents a step. Referring to the tree structure of context instances, there are two possible directions for a step: (i) from child to parent context instance (e.g., from c₁² to c₁¹), where μᵢ is denoted as . . . ; (ii) from parent to child context instance (e.g., from c₂² to c₁¹), where μᵢ denoted as Cᵢ(p). In Cᵢ(p), Cᵢ is the type of child context instance and p is predicate on any metric λₖ in context cᵢ. The predicate p is used to identify which child context instance in the path. When p is null, all the context instances of context type Cᵢ are matched. In the map expression of equation (2), output of map expression is Item.stockLevel and one of the operands is Customer.customerOrders.amount that belongs to a different context of the map expression, then the context navigation path for locating the operand is </ . . . /store( )/customer (item.itemID IN SELECT (customerOrder.lineItems.itemID))> (as shown in FIG. 6). The path consists of two child-parent steps and two parent-child steps. The first two child-parent steps reach the root context, and then step store( ) matches all the context instances with context type store, and finally the step customer(item.itemID IN SELECT (customerOrder.lineItems.itemID)) matches all the context instances of customer that her coustomerOrder contains lineItem having the same itemID as the context instance item.
   In the solution according to the present invention, the model transformer computes the context navigation path for each operand in expressions, which facilitates the searching of context instances. The computation results are saved in table expressionInput (the field input2ExpPath and exp2InputPath).

As described above, the amount of information (i.e., context objects) manipulated by the runtime may not able to completely loaded into memory. Therefore, a solution to persist the context objects is required. The intuitive choice is adopting an object store (i.e., persistent contexts as objects). However, it is very costly when referencing metrics attributes in map expression: entire contexts objects need to be constructed in memory. In fact, in most cases, the operands in map expressions are some metric attributes instead of whole metric. For the sake of performance and scalability, instead of adopting object store, a relational database is used to implement the runtime datastore. Therefore, when evaluating a map expression, the runtime engine can manipulate the operands, without constructing entire context objects. When adopting a relational approach to persist contexts, mapping between context objects and relational tables is required.

An intuitive design choice for a runtime data store is to save all the context instance data as a record in a predefined table. In such an approach, the mapping between the context object and data store is simple. However, this requires creating new tables when there are changes in the information logic of a newer observation model. Considering the dynamics of business processes, evolution of the observation model may occur frequently. Therefore, the runtime data store may need to maintain a large number of tables for different version of the observation model. In order to overcome this limitation, a unified data schema is used that observation models can map to. This approach requires more complicated mappings between the context object and the data store. However, these mappings can be done at buildtime, and will not incur any performance penalty at runtime.

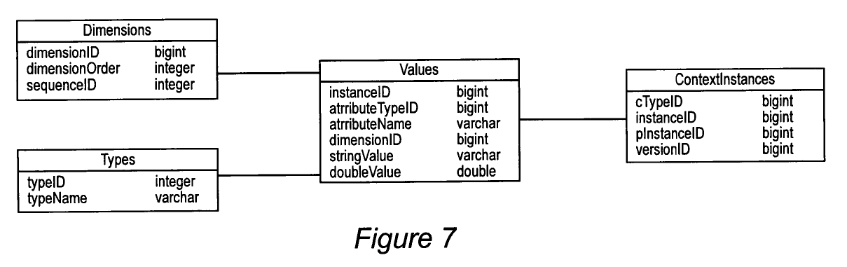

In the solution according to the present invention, the BPM server separates the organization of contexts from the data of the contexts (see FIG. 7), wherein one table ContextInstances (C) is used to store the context instances, while another table Values (V) is used to store the data of contexts. It should be noted that the content of the contexts are stored vertically in table Values. In table Values, each elementary element in contexts has a record in the table and contextInstanceID is unique for each context instance. Using contextInstanceID, the records in the table can be correlated to individual context instances. Table Dimensions (D) is used to store the dimension information when there exists array type of data elements in contexts. By specifying dimensionOrder and sequenceID, the datastore can store any dimension array of data in a context. Further, the table Types (T) gives type information.

Assuming a multiple value metric Order contains the orders for customers, where an order consists of an array of attribute lineItem. The attribute itself is a structure that has two fields: price and itemName. In the runtime datastore, such a metric can be persisted as shown in table 1. In this example, in the third row of table Values, dimensionID is 2, where in table Dimensions, two entries' dimensionID is 2: the first one's dimensionOrder is 1 and sequenceID is 2 and second one's dimensionOrder is 2 and sequenceID is 1. This indicates that position of third row in table Values is: 1 in first dimension, and 2 in second dimension. The first dimension represents the order sequence and the second dimension represents sequence of the lineItem, therefore, the row represents the attribute in first order and second lineItem.

The following map expression is used as an example to illustrate how the code is generated for evaluating expressions.
c,λ=x(c₁,λ₁,c₂,λ₂, . . . ,cₙ,λₙ,γ₁,γ₂, . . . γₘ,ε₁,ε₂, . . . ,εₖ) (2)
Generating code for expression evaluation consists of three steps: (1) generating code for retrieval the value of each operand; (2) generating code for executing operator X; (3) generating code for assigning the value to metric λ. In the rest of section, we present each step of in detail.

In first step, the model compiler generates queries to retrieve the operand's value. Here, we use metric attribute as an example of operands to illustrate our code generation solution. By specifying attributes of the metric and context navigation path, the metric operand λᵢ in expression (2) can be further refined as:
λᵢ</μ₁/μ₂/ . . . /μₖ≦.aᵢ[d₁,s₂, . . . ,s₁](3)
The query generation consists of two phases: (i) generating queries to retrieve the context instance; (ii) generating queries to retrieve the content of the metric attribute. How to generate queries to retrieve the context instance that the metric λᵢ belongs to first. In order to selfjoin the table ContextInstances, it is renamed as Cᵢ according to each step in context navigation path:
ρ(Cᵢ,C),iε[1 . . . k] (4)
Then the query for retrieval target context instance is:
ρ(p,π_{c}_{^{k}}_{,instanceID}(C₁ [symbol] _{q1}C₂ [symbol] _{q2} . . . [symbol] _{qk-1}Cₖ)) (5)
This query joins all the contexts in the context path and then projects the destination context instances' instanceID. In the query, qⱼ(jε[1 . . . k−1]) is the equijoin predicate for Cⱼ and Cⱼ₊₁. The generation of equijoin predicate qⱼ is based on the direction of step μᵢ. In case of child-parent step, predicate qⱼ is C_{j.}pInstanceID=Cⱼ₊₁.instanceID, indicating Cⱼ's parent context is Cⱼ₊₁. In case of parent-child step, predicate qⱼ is C_{j.}instanceID=C_{j+1.}pInstanceID, indicating Cⱼ is parent context of Cⱼ₊₁. Further, in second case, if the predicate in the step m is not null, then query that search for context instance that can satisfy the predicate p is:
ρ(Vⱼ₋₁,π_{instanceID}(σ_{V.elementName=k.nameˆp}′(V))) (6)
This query selects tuples that can satisfy the predicates from table Values and projects the instanceID. In the query, p′ is transformed from p by replacing the metric λₖ with V.stringValue (resp. V.doubleValue) in predicate p, if the key metric's data type is string (resp. double). In this case, the query needs to be refined as:
ρ(P,π_{C}_{_{k.}}_{instanceID}(C₁ [symbol] _{q1}C₂ . . . Cⱼ [symbol] _{q}_{ⱼ}Cⱼ₊₁_{C}_{_{j+1.}}_{instanceID=V}_{_{j+1.}}_{instanceID}Vⱼ₊₁ . . . [symbol] _{qk-1}Cₖ) (7)
This query also joins the table Values to select the right child context instances. Now we know which context instance that metric λᵢ belongs to. In the following, there is illustrated how to retrieve its attribute value. If the aᵢ's data type is string, then the query generated for retrial aᵢ is:
ρ(Vᵢ,π_{stringValue.dimensionID} (8)
(σ_{V.itmeName=a}_{ᵢ}(V_{instanceID}P)))

This query joins the table Values with context instances that are specified by the context path. As dimension expression of aᵢ is [d₁, d₂, . . . , d₁], the extra queries about the dimension is generated as:
ρ(D_{i,k},(σ_{D.dimensionOrder=kˆD.sequenceID=d}_{ₖ}D))kε[1 . . . l] (9)

It should be noted that each above query is according to a dimension of the metric, which selects the tuple in table dimensions that represent the dimension is specified by the operand expression. By equijoining d_{i,k} on dimensionID to select dimension information on same metric, we have
ρ(Vᵢ′,π_{stringValue}(Vᵢ [symbol] _{dimensionID}D_{i,k})) (10)
where Vᵢ′ represents the value of metric operand expression λᵢ. It should be noted that events are considered as metrics and saved in correlated context instances. Generating code for retrieving event values can adopt the same approach for metric values. Also, an external data source is represented as a query in our model. Therefore, all the operands in the expression can be retrieved by generated or provided queries.

Now we discuss the second step, that of generating code for executing operators in expression. We distinguish two types of operators: (1) elementary operators are provided by the Java virtual machine; (2) advanced operators (e.g., set operator) and function can be implemented as Java methods. Once all the operands in expression are retrieved, by executing the operator, we can have the value for metric X. Therefore, in final step, an update or insert statement is generated to set the value of metric λ in runtime datastore. It should be noted that for each expression, a Java class is generated and the Java class name is saved in table Expression (in the field evaluationClass).

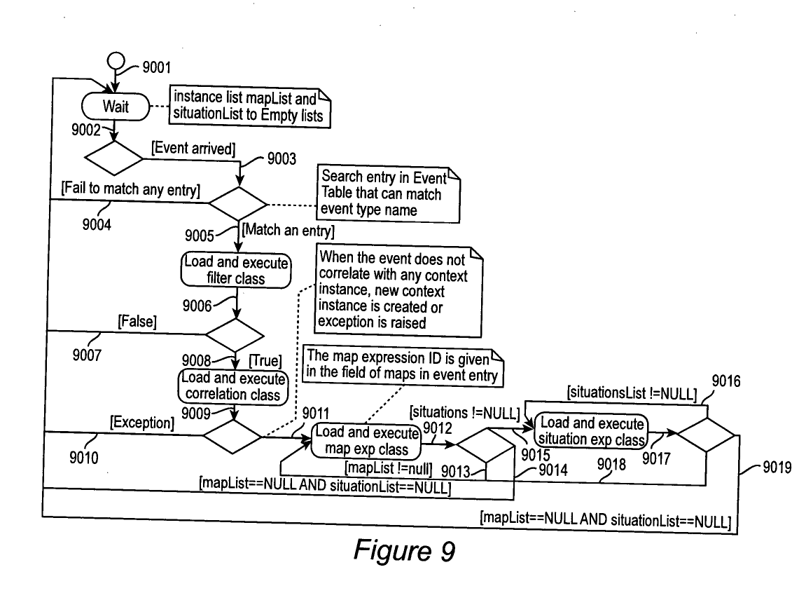

In runtime, the interpreter (runtime engine) is responsible for processing the incoming events. FIG. 9 illustrates main route of the runtime engine on processing events and computing metric values. In the route, first of all runtime engine gets initiated, in Step 9001, where two list mapList and situationList are initiated as empty lists. Then it waits for in coming events in Step 9002. When an incoming event arrives, in Step 9003, it searches entry in Event table by matching event type name. If no any entry is found, then it returns to waiting state in Step 9004. If it matches an event entry, then it loads and executes the filter class in Step 9005. If execution of the filter is false, then it returns to waiting state, Step 9007. If execution of filter is true, then it loads and executes correlation class. If the execution result of correlation class is an exception, it then returns to waiting state in Step 9010. If the execution result of correlation creates a new context instance ID or correlates to an existing context instance, it first identifies a collection of map expression that is directly triggered by the incoming event and adds all the map expression into the list mapList. It loads and executes first available map expression class in the list mapList in Step 9011. After execution of a map expression class, it first removes the map expression from the list mapList and checks the entry in table metric based on the output metric of the map, wherein the field situations gives all the situations need to be evaluated while the field maps gives the maps need to evaluated as the consequence of the change value the output metric in Step 9012. Then it adds all the expression in maps into list mapList and all the expression in situations into list situationList. If both mapList and are situationList is empty, then it completes the processing of the incoming event and returns to the waiting state in Step 9014. If mapList is not empty, then it loads and executes the next matched map expression in Step 9013. If the situationList is not empty, then it loads and executes situation expression class in step 9015. When the execution is completed, it first removes the situation expression form the situationList and checks the entry in situation table based on the evaluation result of each expression, wherein the all the expression in field situations is added into the situationList as the consequence of an occurrence situation in Step 9017. If the situationList is not empty, it will load the next situation expression in situationList in Step 9016. Again, if mapList is not empty, then it loads and executes a map expression in the mapList in Step 9018. If both If both mapList and situationList are empty, then it completes the processing of the incoming event and returns to the waiting state in Step 9019.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A method of model-driven business performance management implementing a hybrid compile-interpret process comprising the steps of:
decomposing a context-oriented observation model containing a hierarchy of contexts into information logic and model specific logic;
transforming the context-oriented observation model into an event-oriented model;
using a relational datastore to provide persistent support for runtime objects;
using a model compiler to generate libraries for model specific logic in the observation model; and
using a runtime engine to process events and compute metric values.

2. The method of model-driven business performance management recited in claim 1, wherein the step of decomposing an observation model comprises the steps of:
refactoring information logic to reorganize the information logic into a table for each type of element in the observation model; and
pre-processing model specific logic to determine expressions that should be executed and navigation paths of generated context instances and associated metrics which form a tree structure.

3. The method of model-driven business performance management recited in claim 1, wherein the step of using a relational datastore to provide persistent support for runtime objects comprises the steps of:
storing type information and value information separately; and
storing the value information vertically.

4. The method of model-driven business performance management recited in claim 1, wherein the step of using a model compiler to generate libraries for model specific logic in the observation model comprises the steps of:
generating code for retrieval of a value of each operand;
generating code for an executing operator; and
generating code for assigning the retrieved value to a metric.

5. The method of model-driven business performance management recited in claim 1, wherein the step of using a runtime engine to process events and compute metric values comprises the steps of:
loading a generated runtime library based on refactored model information;
executing the runtime library to compute metric values and detecting situations; and
emitting situation events when situations are detected.

6. A method of model-driven business performance management implementing a hybrid compile-interpret process comprising the steps of:
decomposing a context-oriented observation model containing a hierarchy of contexts into information logic and model specific logic;
transforming the context-oriented observation model into an event-oriented model;
using a relational datastore to provide persistent support for runtime objects;
using a model compiler to generate libraries for model specific logic in the observation model, said model compiler generating code for retrieval of a value of each operand, generating code for an executing operator, and generating code for assigning the retrieved value to a metric; and
using a runtime engine to process events and compute metric values, said runtime engine loading a generated runtime library based on refactored model information, executing the runtime library to compute metric values and detecting situations, and emitting situation events when situations are detected.

7. A system for model-driven business performance management, comprising:
a model editor that allows a user to define an observation model;
a model transformer that can transform a context-oriented observation model to an event-triggered execution model;
a model compiler that can generate mold specific runtime code for model execution;
a runtime datastore that provides persistent storage of context status, including metric values and situations; and
a model interpreter that can interpret refactored model information and dynamically load a model-specific runtime library to execute the observation model.

8. The system of claim 7, wherein a model editor provides tools and a metamodel allows observation model developers to define observation models.

9. The system of claim 8, wherein the observation model includes a set of contexts that are organized in a hierarchical structure.

10. The system of claim 9, wherein said contexts include a collection of entities, including metrics, situations and events, and expressions for event filtering, correlation, metric value updating and situation detection.

11. The system of claim 7, wherein the model transformer has a collection of tables to store refactored observation models.

12. The system of claim 7, wherein a runtime datastore has a collection of tables to store runtime state of context instances, including metric values and situation detection results.
